(19) United States
(12) Patent Application Publication
(10) Pub. No.: US 2026/0255101 A1
(43) Pub. Date: Aug. 27, 2026

(54) ELECTRONIC DEVICE COMPRISING WAVEGUIDE FOR SPEAKER

(71) Applicants: Samsung Electronics Co., Ltd., Suwon-si (KR); KOREA ADVANCED INSTITUTE OF SCIENCE AND TECHNOLOGY, Daejeon (KR)

(72) Inventors: Seongkwan YANG, Suwon-si (KR); Wonju JEON, Daejeon (KR); Kiwon KIM, Suwon-si (KR); Taeyoung PARK, Suwon-si (KR); Byounghee LEE, Suwon-si (KR); Hunki LEE, Suwon-si (KR); Eunjin YANG, Daejeon (KR); Eunji CHOI, Daejeon (KR); Kiyong LEE, Daejeon (KR)

(21) Appl. No.: 19/648,349

(22) Filed: Apr. 15, 2026

Related U.S. Application Data
(63) Continuation of application No. PCT/KR2024/013260, filed on Sep. 3, 2024.

(30) Foreign Application Priority Data
Oct. 31, 2023 (KR) 10-2023-0148657
Dec. 15, 2023 (KR) 10-2023-0183683

(51) Int. Cl. H04R 1/34; H04M 1/03; H04R 1/28

(52) U.S. Cl. CPC H04R 1/345; H04M 1/035; H04R 1/2888; H04R 2499/11

(57) ABSTRACT

A portable communication device is provided. The portable communication device includes a housing including a speaker hole extending in a first direction, a display, coupled to the housing, extending in a second direction perpendicular to the first direction, a speaker disposed in the housing, the speaker being configured to output audio toward the display, and a waveguide for transmitting the audio to an outside of the portable communication device, the waveguide extending from the speaker to the speaker hole, wherein the waveguide includes a first surface, which is at least partially bent, and a second surface facing the first surface, the second surface being spaced apart from the first surface, wherein the speaker hole is formed along a periphery of the display and is configured to emit the audio, which is propagated in the second direction through the first surface and the second surface, toward the outside in the first direction, and wherein the second surface is at least partially spaced apart from a virtual line parallel to the first surface according to a ratio of a length of the second surface and a distance from a first point on the second surface to a second point spaced apart along the second surface.

### CROSS-REFERENCE TO RELATED APPLICATION(S)

This application is a continuation application, claiming priority under 35 U.S.C. § 365(c), of an International application No. PCT/KR2024/013260, filed on Sep. 3, 2024, which is based on and claims the benefit of a Korean patent application number 10-2023-0148657, filed on Oct. 31, 2023, in the Ministry of Intellectual Property (MOIP), and of a Korean patent application number 10-2023-0183683, filed on Dec. 15, 2023, in the Ministry of Intellectual Property (MOIP), the disclosure of each of which is incorporated by reference herein in its entirety.

### BACKGROUND

### 1. Field

The disclosure relates to an electronic device including a waveguide for a speaker.

### 2. Description of Related Art

An electronic device may include a speaker for providing auditory information or various user experiences to a user. The electronic device may include a waveguide for transmitting audio output from the speaker to an outside of the electronic device. In order to meet user requirements, the waveguide may require a structure configured to improve sound quality of sound emitted from the speaker through the waveguide to the outside of the electronic device.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device including a waveguide for a speaker.

Additional aspects will be set forth in part in the description which follows and, in part, will be apparent from the description, or may be learned by practice of the presented embodiments.

In accordance with an aspect of the disclosure, a portable communication device is provided. The portable communication device includes a housing including a speaker hole extending in a first direction, a display coupled to the housing, extending in a second direction perpendicular to the first direction, a speaker disposed in the housing, the speaker being configured to output audio toward the display, and a waveguide for transmitting the audio to an outside of the portable communication device, the waveguide extending from the speaker to the speaker hole, wherein the waveguide includes a first surface, which is at least partially bent, and a second surface facing the first surface, the second surface being spaced apart from the first surface, wherein the speaker hole is formed along a periphery of the display and is configured to emit the audio, which is propagated in the second direction through the first surface and the second surface, toward the outside in the first direction, and wherein the second surface is at least partially spaced apart from a virtual line parallel to the first surface according to a ratio of a length of the second surface and a distance from a first point on the second surface to a second point spaced apart along the second surface.

In accordance with another aspect of the disclosure, a portable communication device is provided. The portable communication device includes a housing including a speaker hole, a speaker disposed in the housing, the speaker being configured to output audio, and a waveguide for transmitting the audio to an outside of the portable communication device, the waveguide extending from the speaker to the speaker hole, wherein the waveguide includes a first surface, which is at least partially bent, and a second surface facing the first surface, the second surface being spaced apart from the first surface, and wherein the second surface is at least partially spaced apart from a virtual line parallel to the first surface according to a ratio of a length of the second surface and a distance from a first point on the second surface to a second point spaced apart along the second surface.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2A is a drawing illustrating an electronic device according to an embodiment of the disclosure;

FIG. 2B is an exploded perspective view of an electronic device according to an embodiment of the disclosure;

FIG. 3A illustrates a portion of an electronic device according to an embodiment of the disclosure;

FIG. 3B is a partial cross-sectional view of the electronic device cut along line A-A′ of FIG. 2A according to an embodiment of the disclosure;

FIGS. 4A and 4B illustrate a portion of an electronic device according to various embodiments of the disclosure; and

FIG. 5 is a graph illustrating sound pressure level according to a shape of a waveguide and frequency of sound according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

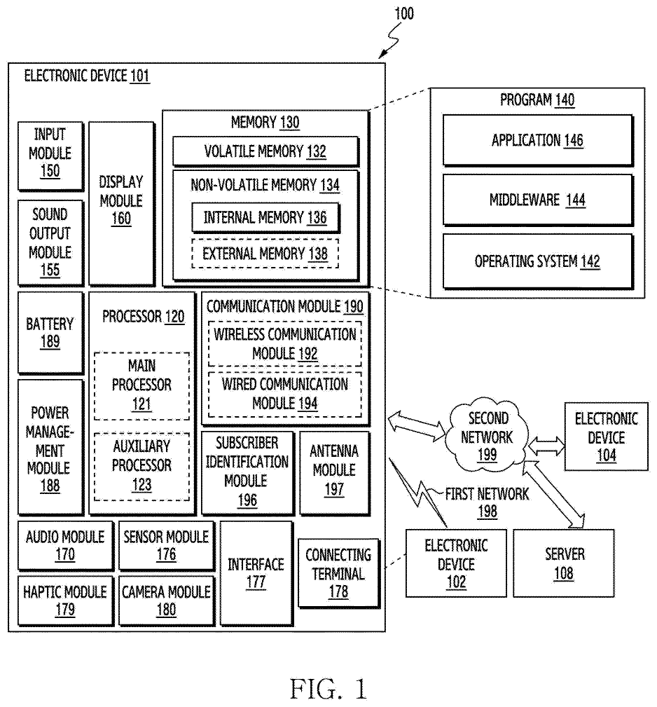

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™ wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth-generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on fifth-generation (5G) communication technology or IoT-related technology.

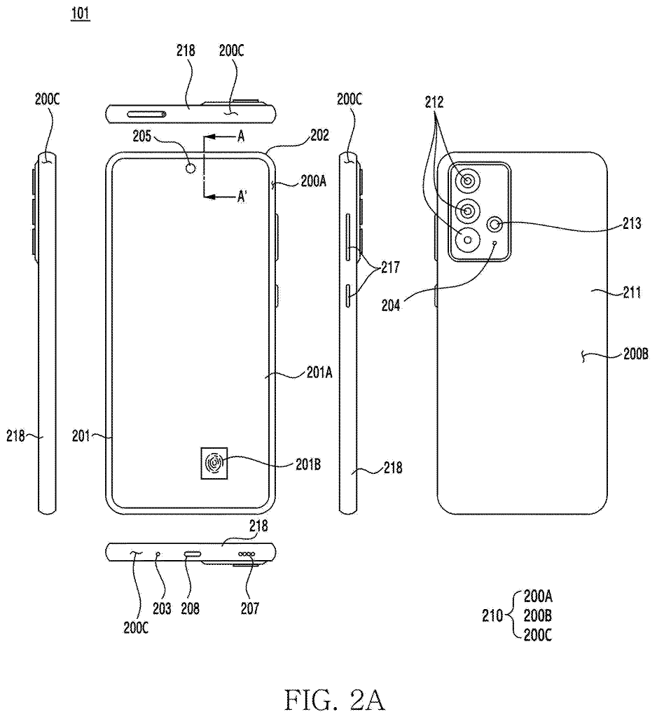

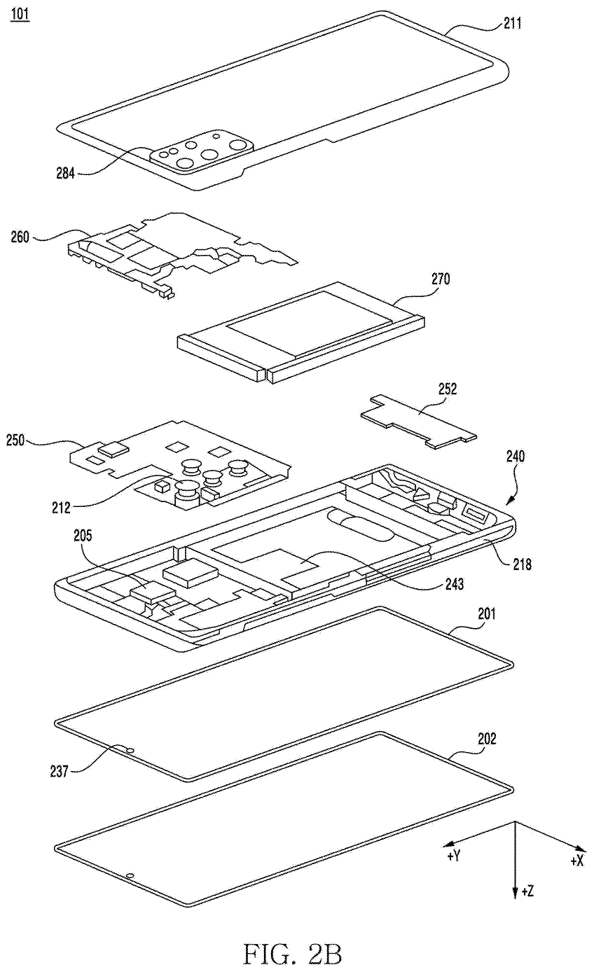

FIG. 2A is a drawing illustrating an electronic device according to an embodiment of the disclosure.

Referring to FIG. 2A, an electronic device 101 according to an embodiment may include a housing 210 forming an exterior of the electronic device 101. For example, the housing 210 may include a front surface 200A, a rear surface 200B, and a side surface 200C surrounding a space between the front surface 200A and the rear surface 200B. According to an embodiment, the housing 210 may refer to a structure forming at least a portion of the front surface 200A, the rear surface 200B, and/or the side surfaces 200C.

The electronic device 101 according to an embodiment may include a substantially transparent front plate 202. According to an embodiment, the front plate 202 may form at least a portion of the front surface 200A. According to an embodiment, the front plate 202 may include, for example, a glass plate including various coating layers, or a polymer plate, but is not limited thereto.

The electronic device 101 according to an embodiment may include a substantially opaque rear plate 211. According to an embodiment, the rear plate 211 may form at least a portion of the rear surface 200B. According to an embodiment, the rear plate 211 may be formed of coated or colored glass, ceramic, polymer, metal (e.g., aluminum, stainless steel (STS), or magnesium), or a combination of at least two of the materials.

The electronic device 101 according to an embodiment may include a side bezel structure (or a side member) 218. According to an embodiment, the side bezel structure 218 may be coupled to the front plate 202 and/or the rear plate 211 to form at least a portion of the side surface 200C of the electronic device 101. For example, the side bezel structure 218 may form the entire side surface 200C of the electronic device 101, and for another example, the side bezel structure 218 may form the side surface 200C of the electronic device 101 together with the front plate 202 and/or the rear plate 211.

Unlike the illustrated embodiment, when the side surface 200C of the electronic device 101 is partially formed by the front plate 202 and/or the rear plate 211, the front plate 202 and/or the rear plate 211 may include a region that is curved from its periphery toward the rear plate 211 and/or the front plate 202 and extends seamlessly. The extending region of the front plate 202 and/or the rear plate 211 may, for example, be located at both ends of a long edge of the electronic device 101, but is not limited to the above-described example.

According to an embodiment, the side bezel structure 218 may include metal and/or polymer. According to an embodiment, the rear plate 211 and the side bezel structure 218 may be integrally formed and may include the same material (e.g., a metal material such as aluminum), but are not limited thereto. For example, the rear plate 211 and the side bezel structure 218 may be formed as separate configurations and/or may include materials different from each other.

According to an embodiment, the electronic device 101 may include at least one of a display 201, audio modules 203, 204, and 207, a sensor module (not illustrated), camera modules 205, 212, and 213, a key input device 217, a light emitting element (not illustrated), and/or a connector hole 208. According to an embodiment, the electronic device 101 may omit at least one (e.g., the key input device 217 or the light emitting element (not illustrated)) of the components or may additionally include another component.

According to an embodiment, the display 201 may be visually exposed through a substantial portion of the front plate 202. For example, at least a portion of the display 201 may be visible through the front plate 202 forming the front surface 200A. According to an embodiment, the display 201 may be disposed on a back surface of the front plate 202.

According to an embodiment, an outer shape of the display 201 may be formed to be substantially the same as an outer shape of the front plate 202 adjacent to the display 201. According to an embodiment, in order to expand an area in which the display 201 is visually exposed, spacing between an outer edge of the display 201 and an outer edge of the front plate 202 may be formed to be substantially the same.

According to an embodiment, the display 201 (or the front surface 200A of the electronic device 101) may include a screen display area 201A. According to an embodiment, the display 201 may provide visual information to a user through the screen display area 201A. In the illustrated embodiment, when the front surface 200A is viewed from the front, the screen display area 201A is illustrated as being spaced apart from an outer edge of the front surface 200A and located on an inner side of the front surface 200A, but is not limited thereto. In another embodiment, when the front surface 200A is viewed from the front, at least a portion of a periphery of the screen display area 201A may substantially coincide with a periphery of the front surface 200A (or the front plate 202).

According to an embodiment, the screen display area 201A may include a sensing area 201B configured to obtain biometric information of the user. Herein, “the screen display area 201A includes the sensing area 201B” may be understood to mean that at least a portion of the sensing area 201B may be overlapped with the screen display area 201A. For example, the sensing area 201B may correspond to an area capable of displaying visual information by the display 201 like another area of the screen display area 201A, and additionally may correspond to an area capable of obtaining biometric information (e.g., a fingerprint) of the user. According to an embodiment, the sensing area 201B may be formed in the key input device 217.

According to an embodiment, the display 201 may include a region in which a first camera 205 is located. According to an embodiment, an opening may be formed in the region of the display 201, and the first camera 205 (e.g., a punch hole camera) may be at least partially disposed in the opening to face the front surface 200A. In this case, the screen display area 201A may surround at least a portion of a periphery of the opening. According to an embodiment, the first camera 205 (e.g., an under display camera (UDC)) may be disposed under the display 201 to overlap with the region of the display 201. In this case, the display 201 may provide visual information to the user through the region, and additionally, the first camera 205 may obtain an image corresponding to a direction toward the front surface 200A through the region of the display 201.

According to an embodiment, the display 201 may be coupled to or disposed adjacent to touch sensing circuitry, a pressure sensor capable of measuring intensity (pressure) of a touch, and/or a digitizer detecting a magnetic field type stylus pen.

According to an embodiment, the audio modules 203, 204, and 207 may include microphone holes 203 and 204 and a speaker hole 207.

According to an embodiment, the microphone holes 203 and 204 may include a first microphone hole 203 formed in a partial region of the side surface 200C and a second microphone hole 204 formed in a partial region of the rear surface 200B. A microphone (not illustrated) for obtaining external sound may be disposed inside the microphone holes 203 and 204. The microphone may include a plurality of microphones so as to detect a direction of sound.

According to an embodiment, the second microphone hole 204 formed in a partial region of the rear surface 200B may be disposed adjacent to the camera modules 205, 212, and 213. For example, the second microphone hole 204 may obtain sound according to operation of the camera modules 205, 212, and 213. However, it is not limited thereto.

According to an embodiment, the speaker hole 207 may include an external speaker hole 207 and a receiver hole for calls (not illustrated). The external speaker hole 207 may be formed in a portion of the side surface 200C of the electronic device 101. According to an embodiment, the external speaker hole 207 may be implemented as one hole together with the microphone hole 203. Although not illustrated, the receiver hole for calls (not illustrated) may be formed in another portion of the side surface 200C. For example, the receiver hole for calls may be formed on an opposite side of the external speaker hole 207 on the side surface 200C. For example, based on the illustration of FIG. 2A, the external speaker hole 207 may be formed on the side surface 200C corresponding to a lower end portion of the electronic device 101, and the receiver hole for calls may be formed on the side surface 200C corresponding to an upper end portion of the electronic device 101. However, it is not limited thereto, and according to an embodiment, the receiver hole for calls may be formed at a position other than the side surface 200C. For example, the receiver hole for calls may be formed by a spaced-apart region between the front plate 202 (or the display 201) and the side bezel structure 218.

According to an embodiment, the electronic device 101 may include at least one speaker (not illustrated) configured to output sound to an outside of the housing through the external speaker hole 207 and/or the receiver hole for calls (not illustrated).

According to an embodiment, the sensor module (not illustrated) may generate an electrical signal or a data value corresponding to an operating state inside the electronic device 101 or an environmental state outside the electronic device 101. For example, the sensor module may include at least one of a proximity sensor, an HRM sensor, a fingerprint sensor, a gesture sensor, a gyro sensor, a barometric pressure sensor, a magnetic sensor, an acceleration sensor, a grip sensor, a color sensor, an infrared (IR) sensor, a biometric sensor, a temperature sensor, a humidity sensor, or an illuminance sensor.

According to an embodiment, the camera modules 205, 212, and 213 may include the first camera 205 disposed to face the front surface 200A of the electronic device 101, a second camera 212 disposed to face the rear surface 200B, and a flash 213.

According to an embodiment, the second camera 212 may include a plurality of cameras (e.g., a dual camera, a triple camera, or a quad camera). However, the second camera 212 is not necessarily limited to including a plurality of cameras, and may include one camera.

According to an embodiment, the first camera 205 and the second camera 212 may include one or a plurality of lenses, an image sensor, and/or an image signal processor.

According to an embodiment, the flash 213 may include, for example, a light emitting diode or a xenon lamp. According to an embodiment, two or more lenses (an infrared camera, a wide-angle lens and a telephoto lens) and image sensors may be disposed on a surface of the electronic device 101.

According to an embodiment, the key input device 217 may be disposed on the side surface 200C of the electronic device 101. According to an embodiment, the electronic device 101 may not include some or all of the key input devices 217, and the key input device 217 that is not included may be implemented in another form, such as a soft key, on the display 201.

According to an embodiment, the connector hole 208 may be formed on the side surface 200C of the electronic device 101 so that a connector of an external device may be accommodated. A connecting terminal electrically connected to the connector of the external device may be disposed in the connector hole 208. The electronic device 101 according to an embodiment may include an interface module for processing an electrical signal transmitted and received through the connecting terminal.

According to an embodiment, the electronic device 101 may include a light emitting element (not illustrated). For example, the light emitting element (not illustrated) may be disposed on the front surface 200A of the housing. The light emitting element (not illustrated) may provide state information of the electronic device 101 in the form of light. According to an embodiment, the light emitting element (not illustrated) may provide a light source in conjunction with operation of the first camera 205. For example, the light emitting element (not illustrated) may include an LED, an IR LED, and/or a xenon lamp.

FIG. 2B is an exploded perspective view of an electronic device according to an embodiment of the disclosure.

Hereinafter, redundant descriptions of components having the same reference numerals as those above-described are omitted.

According to an embodiment, an electronic device 101 may be referred to as a portable communication device for communication with an external electronic device (e.g., the electronic device 102 of FIG. 1).

Referring to FIG. 2B, the electronic device 101 according to an embodiment may include a frame structure 240, a first printed circuit board 250, a second printed circuit board 252, a cover plate 260, and a battery 270.

According to an embodiment, the frame structure 240 may include a side bezel structure 218 forming an exterior (e.g., the side surface 200C of FIG. 2A) of the electronic device 101 and a support portion 243 extending inward from the side bezel structure 218. According to an embodiment, the frame structure 240 may be disposed between a display 201 and a rear plate 211. According to an embodiment, the side bezel structure 218 of the frame structure 240 may surround a space between the rear plate 211 and a front plate 202 (and/or the display 201), and the support portion 243 of the frame structure 240 may extend from the side bezel structure 218 within the space.

According to an embodiment, the frame structure 240 may support or accommodate other components included in the electronic device 101. For example, the display 201 may be disposed on a surface of the frame structure 240 facing a direction (e.g., a +z direction), and the display 201 may be supported by the support portion 243 of the frame structure 240. For example, the first printed circuit board 250, the second printed circuit board 252, the battery 270, and a second camera 212 may be disposed on another surface of the frame structure 240 facing a direction (e.g., a −z direction) opposite to the direction. The first printed circuit board 250, the second printed circuit board 252, the battery 270, and the second camera 212 may be respectively seated in a recess defined by the side bezel structure 218 and/or the support portion 243 of the frame structure 240.

According to an embodiment, the first printed circuit board 250, the second printed circuit board 252, and the battery 270 may be coupled to the frame structure 240, respectively. For example, the first printed circuit board 250 and the second printed circuit board 252 may be fixedly disposed on the frame structure 240 through a coupling member such as a screw. For example, the battery 270 may be fixedly disposed on the frame structure 240 through an adhesive member (e.g., double-sided tape). However, it is not limited to the above-described example.

According to an embodiment, the cover plate 260 may be disposed between the support portion 243 and the rear plate 211. According to an embodiment, the cover plate 260 may be disposed on the first printed circuit board 250. For example, the cover plate 260 may be disposed on a surface of the first printed circuit board 250 facing the −z direction.

According to an embodiment, the cover plate 260 may at least partially overlap with the first printed circuit board 250 with respect to the z-axis. According to an embodiment, the cover plate 260 may cover at least a partial region of the first printed circuit board 250. Through this, the cover plate 260 may protect the first printed circuit board 250 from physical impact or prevent separation of a connector coupled to the first printed circuit board 250.

According to an embodiment, the cover plate 260 may be fixedly disposed on the frame structure 240 through a coupling member (e.g., a screw), or may be coupled to the frame structure 240 together with the first printed circuit board 250 through the coupling member.

According to an embodiment, the display 201 may be disposed between the frame structure 240 and the front plate 202. For example, the front plate 202 may be disposed on a side (e.g., the +z direction) of the display 201, and the frame structure 240 may be located on another side (e.g., the −z direction).

According to an embodiment, the front plate 202 may be coupled to the display 201. For example, the front plate 202 and the display 201 may be adhered to each other through an optical adhesive member (e.g., optically clear adhesive (OCA) or optically clear resin (OCR)) interposed therebetween.

According to an embodiment, the front plate 202 may be coupled to the frame structure 240. For example, when viewed in the z-axis direction, the front plate 202 may include an outer portion extending outside the display 201, and may be adhered to the frame structure 240 through an adhesive member (e.g., double-sided tape) disposed between the outer portion of the front plate 202 and the frame structure 240 (e.g., the side bezel structure 218). However, it is not limited to the above-described example.

According to an embodiment, a processor, memory, and/or an interface may be disposed on the first printed circuit board 250 and/or the second printed circuit board 252. The processor may include, for example, one or more of a central processing unit, an application processor, a graphics processing unit, an image signal processor, a sensor hub processor, or a communication processor. The memory may include, for example, a volatile memory or a non-volatile memory. The interface may include, for example, a high definition multimedia interface (HDMI), a universal serial bus (USB) interface, an SD card interface, and/or an audio interface. The interface may electrically or physically connect the electronic device 101 to an external electronic device and may include a USB connector, an SD card/MMC connector, or an audio connector. According to an embodiment, the first printed circuit board 250 and the second printed circuit board 252 may be operatively or electrically connected to each other through a connecting member (e.g., a flexible printed circuit board).

According to an embodiment, the battery 270 may supply power to at least one component of the electronic device 101. For example, the battery 270 may include a rechargeable secondary cell or a fuel cell. At least a portion of the battery 270 may be disposed substantially on the same plane as the first printed circuit board 250 and/or the second printed circuit board 252.

The electronic device 101 according to an embodiment may include an antenna module (not illustrated). According to an embodiment, the antenna module may be disposed between the rear plate 211 and the battery 270. The antenna module may include, for example, a near field communication (NFC) antenna, a wireless charging antenna, and/or a magnetic secure transmission (MST) antenna. The antenna module may, for example, perform short-range communication with an external device or wirelessly transmit and receive power with an external device.

According to an embodiment, a first camera 205 (e.g., a front camera) may be disposed on at least a portion (e.g., the support portion 243) of the frame structure 240 such that a lens may receive external light through a certain region (e.g., a camera region 237) of the front plate 202 (e.g., the front surface 200A of FIG. 1).

According to an embodiment, a second camera 212 (e.g., a rear camera) may be disposed between the frame structure 240 and the rear plate 211. According to an embodiment, the second camera 212 may be electrically connected to the first printed circuit board 250 through a connecting member (e.g., a connector). According to an embodiment, the second camera 212 may be disposed such that a lens may receive external light through a camera region 284 of the rear plate 211 of the electronic device 101.

According to an embodiment, the camera region 284 may be formed on a surface (e.g., the rear surface 200B of FIG. 1) of the rear plate 211. According to an embodiment, the camera region 284 may be formed to be at least partially transparent such that external light may be incident on the lens of the second camera 212. According to an embodiment, at least a portion of the camera region 284 may protrude from the surface of the rear plate 211 by a predetermined height. However, it is not limited thereto, and in another embodiment, the camera region 284 may form substantially the same plane as the surface of the rear plate 211.

According to an embodiment, a housing (e.g., the housing 210 of FIG. 2A) of the electronic device 101 may refer to a configuration or a structure forming at least a portion of the exterior of the electronic device 101. In this regard, at least a portion of the front plate 202, the frame structure 240, and/or the rear plate 211 forming the exterior of the electronic device 101 may be included in the housing 210 of the electronic device 101.

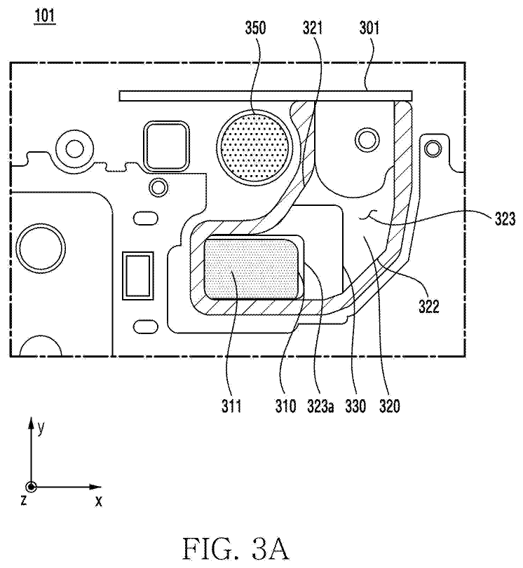

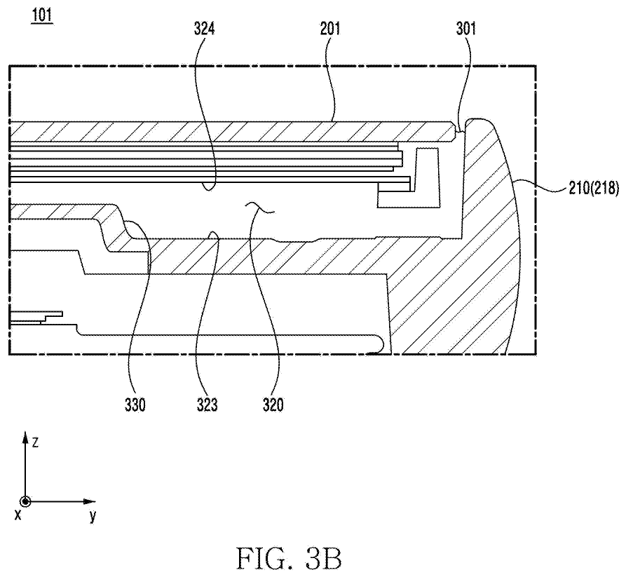

FIG. 3A illustrates a portion of an electronic device according to an embodiment of the disclosure.

FIG. 3B is a partial cross-sectional view of the electronic device cut along line A-A′ of FIG. 2A according to an embodiment of the disclosure.

Referring to FIGS. 3A and 3B, an electronic device 101 may include a housing 210 including a speaker hole 301, a speaker 310, and a waveguide 320.

According to an embodiment, the speaker 310 may be disposed in the housing 210. The speaker 310 may be configured to output audio. For example, the housing 210 may include a front surface (e.g., the front surface 200A of FIG. 2A), a rear surface (e.g., the rear surface 200B of FIG. 2A) opposite to the front surface 200A, and a side surface (e.g., the side surface 200C of FIG. 2A) surrounding a space between the front surface 200A and the rear surface 200B. The speaker 310 may be disposed within the space between the front surface 200A and the rear surface 200B. The speaker 310 may be surrounded by the front surface 200A, the rear surface 200B, and the side surface 200C.

For example, the speaker hole 301 may be disposed toward the front surface 200A of the housing 210. The speaker hole 301 may be formed between a structure disposed on the front surface 200A (e.g., a display 201) and a structure forming at least a portion of the side surface 200C (e.g., a side bezel structure 218). The speaker 310 may be disposed around the front surface 200A and/or the side surface 200C to emit the audio to an outside of the electronic device 101 through the speaker hole 301. The speaker 310 may be disposed to output the audio toward the speaker hole 301.

According to an embodiment, the electronic device 101 may include the display 201. The speaker 310 may include a diaphragm 311 configured to output audio. For example, the display 201 may be attached to a frame structure 240. The display 201 may be at least partially exposed to the outside of the electronic device 101. The display 201 may provide visual information to a user. For example, the speaker 310 may at least partially face the display 201. For example, the speaker 310 may overlap with a portion of the display 201 when the display 201 is viewed from above (e.g., when viewed from a +z direction).

For example, the speaker hole 301 may be at least partially formed between the display 201 and the side bezel structure 218 of the housing 210. The speaker hole 301 may be referred to as a gap between the display 201 and the side bezel structure 218, but is not limited thereto. For example, the diaphragm 311 may be disposed to face the display 201.

For example, although not illustrated, the speaker 310 may include at least one voice coil providing vibration to the diaphragm 311, and a magnet forming a magnetic field. When current flows through the at least one voice coil, a magnetic field formed by the voice coil may interact with a magnetic field formed by the magnet to vibrate the voice coil. Based on the vibration of the voice coil, the diaphragm 311 connected to the voice coil may be configured to vibrate. The speaker 310 may be configured to output audio based on the vibration of the diaphragm 311 caused by the vibration of the voice coil. The speaker 310 may include a yoke forming a magnetic field together with the magnet, but is not limited thereto. The electronic device 101 may include a structure for transmitting the audio output from the speaker 310 to the outside of the electronic device 101 through the speaker hole 301.

According to an embodiment, the waveguide 320 may extend from the speaker 310 to the speaker hole 301 of the housing 210 to transmit the audio output from the speaker 310 to the outside of the electronic device 101. For example, the waveguide 320 may extend from the diaphragm 311 of the speaker 310 to the speaker hole 301. For example, the waveguide 320 may connect the speaker 310 and the speaker hole 301. For example, the waveguide 320 may provide a path for audio output from the speaker 310. For example, the waveguide 320 may be a passage through which the audio output from the diaphragm 311 of the speaker 310 is emitted toward the outside of the electronic device 101. The waveguide 320 may be referred to as an acoustic duct in terms of providing a path for the audio, but is not limited thereto. For example, the waveguide 320 may be a conduit formed in a component (e.g., the frame structure 240 or the side bezel structure 218 of FIG. 2B) of the housing 210.

According to an embodiment, the electronic device 101 may include an electronic component 350 located adjacent to the waveguide 320. For example, the electronic component 350 may include a camera. The electronic component 350 may be disposed toward the front surface 200A of the housing 210 and/or the display 201. For example, the electronic component 350 may be at least partially exposed to the outside of the electronic device 101 through a hole (e.g., the camera region 237 of FIG. 2B) for the electronic component 350. For example, the electronic component 350 may be referred to as a front camera (e.g., the first camera 205 of FIG. 2A) disposed toward the front surface 200A of the housing 210, but is not limited thereto. The electronic component 350 may include at least one of an under display camera (UDC) and a punch hole camera.

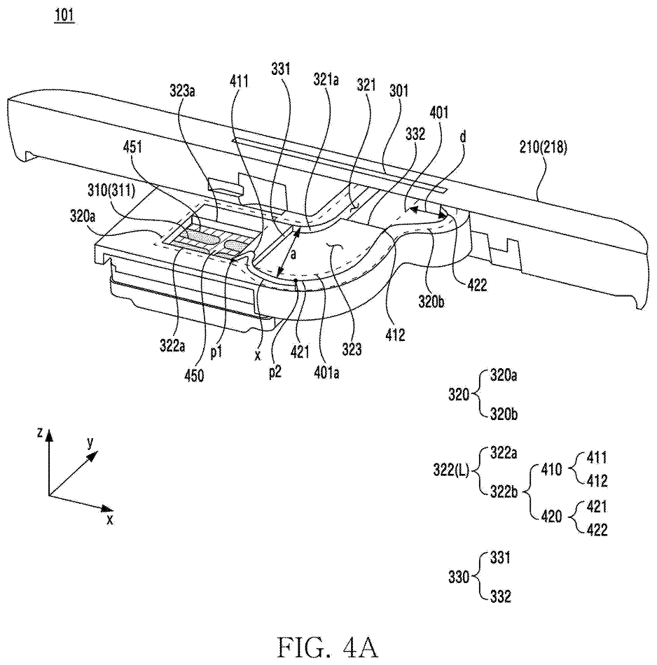

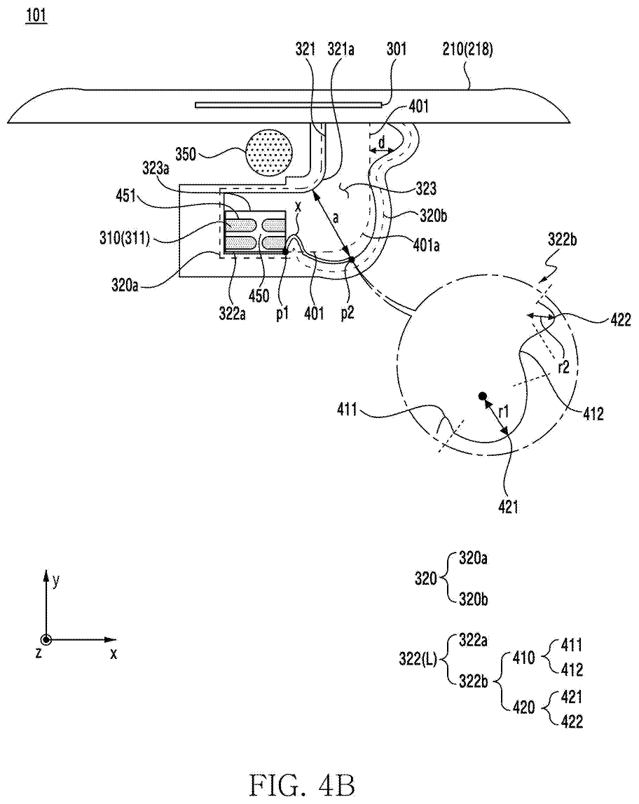

In an embodiment, the waveguide 320 may be at least partially bent. For example, the electronic device 101 may require a structure for improving sound quality of audio output from the speaker 310. The structure of the waveguide 320 for improving the sound quality of the audio will be described below with reference to FIG. 4A and subsequent figures.

According to an embodiment, the waveguide 320 may include a first surface 321 and a second surface 322 facing the first surface 321 and spaced apart from the first surface 321. For example, the first surface 321 may be at least partially bent or may include a curved surface according to a position or a shape of the electronic component 350. For example, the second surface 322 may extend along the first surface 321. The second surface 322 may form a path for audio output from the speaker 310 by being spaced apart from the first surface 321. For example, the second surface 322 may be at least partially bent or include a curved surface along the first surface 321.

For example, the first surface 321 and the second surface 322 may be surfaces extending in a longitudinal direction and/or a length direction of the waveguide 320 extending from the speaker 310 to the speaker hole 301. For example, since the waveguide 320 has a shape which is at least partially bent, a length of the second surface 322 may be longer than a length of the first surface 321. The first surface 321 may be referred to as the shortest side of the waveguide 320 in terms of having a relatively shorter length than the second surface 322, but is not limited thereto. The second surface 322 may be referred to as the longest side of the waveguide 320 in terms of having a relatively longer length than the first surface 321, but is not limited thereto. For example, the first surface 321 and the second surface 322 may at least partially surround a periphery of the speaker 310 when the speaker 310 is viewed from above (e.g., when viewed from the +z direction).

According to an embodiment, the waveguide 320 may include a third surface 323 extending from the first surface 321 to the second surface 322 and a fourth surface 324 facing the third surface 323 and spaced apart from the third surface 323. The fourth surface 324 may be parallel to the third surface 323. For example, the third surface 323 may connect the first surface 321 and the second surface 322. The fourth surface 324 may provide a path for audio output from the speaker 310 together with the first surface 321 and the second surface 322 by being spaced apart from the third surface 323. The fourth surface 324 may connect the first surface 321 and the second surface 322 together with the third surface 323. For example, the fourth surface 324 may extend from the first surface 321 to the second surface 322. For example, the fourth surface 324 may be a surface adjacent to the display 201 among the surfaces 321, 322, 323, and 324 of the waveguide 320. The third surface 323 may be a surface adjacent to the speaker 310 among the surfaces 321, 322, 323, and 324 of the waveguide 320. The third surface 323 may include an opening 323a for allowing audio output from the speaker 310 to pass into an inside of the waveguide 320. The opening 323a may overlap with the diaphragm 311 of the speaker 310 when viewed from above (e.g., when viewed from the +z direction). The fourth surface 324 may be, for example, parallel to the display 201, but is not limited thereto. For example, the third surface 323 and the fourth surface 324 may have a shape which is at least partially flat.

According to an embodiment, the third surface 323 may include at least one step portion 330. For example, the at least one step portion 330 may be a portion of the third surface 323 in which a curved surface is formed. For example, the at least one step portion 330 may change a volume of the waveguide 320 according to a length of the waveguide 320. For example, the at least one step portion 330 may change a cross-sectional area of the waveguide 320 according to the length of the waveguide 320. The third surface 323 may provide additional space of the waveguide 320 by including the at least one step portion 330. The at least one step portion 330 may affect sound quality of the audio output from the speaker 310 to the waveguide 320 by changing the cross-sectional area according to the length of the waveguide 320.

According to an embodiment, audio output from the speaker 310 to the inside of the waveguide 320 may cause resonance or deterioration in sound quality while passing through the waveguide 320. The waveguide 320 may improve the sound quality of the audio by changing a shape of an inner surface of the waveguide 320. For example, the waveguide 320 may improve the sound quality of the audio by changing the shape of the waveguide 320 without disposing a separate resonator for improving the sound quality of the audio passing through the waveguide 320. An internal structure of the waveguide 320 for improving the sound quality of the audio will be described below with reference to FIG. 4A and subsequent figures. According to the above-described embodiment, the electronic device 101 may provide various user experiences to the user by including the waveguide 320 for transmitting audio output from the speaker 310 to the outside of the electronic device 101. For example, the waveguide 320 may provide additional space for electronic components (e.g., a camera) in the electronic device 101 by being at least partially bent.

FIGS. 4A and 4B illustrate a portion of an electronic device according to various embodiments of the disclosure.

Referring to FIGS. 4A and 4B, an electronic device 101 may include a speaker hole 301, a housing 210, a speaker 310 configured to output audio, and a waveguide 320 extending from the speaker 310 to the speaker hole 301 to transmit the audio to an outside of the electronic device 101. The waveguide 320 may include a first surface 321 and a second surface 322 facing the first surface 321 and spaced apart from the first surface 321. According to an embodiment, the waveguide 320 may include a third surface 323 extending from the first surface 321 to the second surface 322 and a fourth surface 324 facing the third surface 323. The third surface 323 may include at least one step portion 330. According to an embodiment, the electronic device 101 may include an electronic component 350 at least partially surrounded by the waveguide 320. According to an embodiment, the electronic device 101 may include a display (e.g., the display 201 of FIG. 2A) coupled to a frame structure 240. The speaker 310 may include a diaphragm 311 configured to output audio.

Hereinafter, redundant descriptions of components having the same reference numerals as those above-described in FIGS. 3A and 3B are omitted.

According to an embodiment, the second surface 322 may be at least partially spaced apart from a virtual line 401 parallel to the first surface 321 according to a ratio of a length L of the second surface 322 and a distance x from a first point p1 on the second surface 322 to a second point p2 spaced apart along the second surface 322.

The virtual line 401 may extend along the first surface 321 in a direction in which the first surface 321 extends. The virtual line 401 may be defined as a line at least partially contacting the second surface 322 and parallel to the first surface 321. According to an embodiment, the first surface 321 may include a first bending portion 321a which is bent. The virtual line 401 parallel to the first surface may include a second bending portion 401a facing the first bending portion 321a and corresponding to the first bending portion 321a.

The first point p1 and the second point p2 may be points located on the second surface 322 and facing the virtual line 401. The first point p1 may be defined as a point disposed on the same plane (e.g., an xy plane) as the second point p2 and fixed in position on the second surface 322. The second point p2 may be defined as a point disposed on the same plane (e.g., the xy plane) as the first point p1 and changeable in position on the second surface 322.

For example, the virtual line 401 may provide a reference axis for the second surface 322. The second surface 322 may have a shape spaced apart from the virtual line 401 according to the ratio of the length L of the second surface 322 and the distance x between the first point p1 on the second surface 322 and the second point p2. For example, according to the ratio of the distance x between the first point p1 and the second point p2 and the length L of the second surface 322, the second surface 322 may be dented in a direction away from the first surface 321 based on the virtual line 401, or may be protruded toward the first surface 321 based on the virtual line 401. For example, according to the ratio of the distance x between the first point p1 and the second point p2 and the length L of the second surface 322, the second surface 322 may have positive curvature or negative curvature as the second surface 322 extends. For example, the second surface 322 may have a shape of a trigonometric function graph using the virtual line 401 as a reference axis by being spaced apart from the virtual line 401 according to the ratio of the distance x between the first point p1 and the second point p2 and the length L of the second surface 322, but is not limited thereto. The second surface 322 may be spaced apart from the virtual line 401 parallel to the first surface 321 according to the ratio of the distance x between the first point p1 and the second point p2 and the length L of the second surface 322, thereby improving sound quality of audio output from the speaker 310 through the waveguide 320.

For example, the waveguide 320 may change a resonance frequency of audio output from the speaker 310. The waveguide 320 may be configured to adjust the resonance frequency by being formed such that the second surface 322 is at least partially spaced apart from the virtual line 401 parallel to the first surface 321 according to the ratio of the distance x between the first point p1 and the second point p2 and the length L of the second surface 322. As the resonance frequency is adjustable through the waveguide 320, the waveguide 320 may improve acoustic radiation efficiency of the audio.

According to an embodiment, a distance d from the virtual line 401 parallel to the first surface 321 to the second surface 322 according to the ratio of the length L of the second surface 322 and the distance x from the first point p1 on the second surface 322 to the second point p2 spaced apart along the second surface 322 may be determined by Equation 1 below.

$$d = {{\sum }_{m = 1}}^{M} {C}_{m} sin ( 2 π mR ) \qquad Equation 1$$

In Equation 1, d represents the distance from the virtual line 401 to the second surface 322. Cm represents an amplitude constant. M represents a composite coefficient. R represents the ratio of the length L of the second surface 322 and the distance x from the first point p1 on the second surface 322 to the second point p2 spaced apart along the second surface 322.

For example, in Equation 1, a portion of the second surface 322 in which the distance d from the virtual line 401 to the second surface 322 has a positive value (e.g., a first peak portion 421 or a second peak portion 422) may be a portion bent in a direction away from the first surface 321 from the virtual line 401. For example, in Equation 1, a portion of the second surface 322 in which the distance d from the virtual line 401 to the second surface 322 has a negative value (e.g., a first valley portion 411 or a second valley portion 412) may be a portion protruding in a direction closer to the first surface 321 from the virtual line 401. For example, in Equation 1, a point at which the distance d from the virtual line 401 to the second surface 322 becomes 0 may be a point at which the virtual line and the second surface 322 intersect.

For example, in Equation 1, the distance d from the virtual line 401 to the second surface 322 may be expressed as a function for the distance x between the first point p1 and the second point p2 through the ratio R of the length L of the second surface 322 and the distance x between the first point p1 and the second point p2. The function and the ratio R may be determined by Equation 2 below.

$$d ( x ) = {\sum }_{m = 1}^{M} {C}_{m} sin ( 2 π m \frac{x}{L} ) , R = \frac{x}{L} \qquad Equation 2$$

In Equation 2, the distance d from the virtual line 401 to the second surface 322 may be determined by the first point p1 and the distance x from the first point p1 to the second point p2 spaced apart along the second surface 322. The second point p2 may be located at an arbitrary point between the first point p1 fixed in position on the second surface 322 and a point at which the second surface 322 contacts the speaker hole 301. According to the distance x between the first point p1 and the second point p2, the second surface 322 may have a shape corresponding to Equation 2 based on the virtual line 401, thereby improving sound quality of audio output to the outside of the electronic device 101 from the speaker 310 through the waveguide 320 and the speaker hole 301.

According to an embodiment, in Equation 1 and/or Equation 2, the composite coefficient M may have a range of 1 to 3. For example, as the composite coefficient M has a range of 1 to 3, the distance d from the virtual line 401 to the second surface 322 may be determined by the equations 3-5 below.

$$d ( x ) = {C}_{1} sin 2 π \frac{x}{L} \qquad Equation 3$$

$$d ( x ) = {C}_{1} sin 2 π \frac{x}{L} + {C}_{2} sin 2 π \frac{2 x}{L} \qquad Equation 4$$

$$d ( x ) = {C}_{1} sin 2 π \frac{x}{L} + {C}_{2} sin 2 π \frac{2 x}{L} + {C}_{3} sin 2 π \frac{3 x}{L} \qquad Equation 5$$

In Equation 1, when the composite coefficient M is 1, with reference also to Equation 3, the distance d from the virtual line 401 to the second surface 322 may be determined by one sine function. In Equation 1, when the composite coefficient M is 2, with reference also to Equation 4, the distance d from the virtual line 401 to the second surface 322 may be determined by a synthesis of two sine functions. In Equation 1, when the composite coefficient M is 3, with reference also to Equation 5, the distance d from the virtual line 401 to the second surface 322 may be determined by a synthesis of three sine functions. The second surface 322 of the waveguide 320 may have a shape of a graph according to a sine function and/or a synthesis of a plurality of sine functions based on the virtual line 401 parallel to the first surface 321 facing the second surface 322, thereby improving sound quality of audio output to the outside of the electronic device 101 from the speaker 310 through the waveguide 320 and the speaker hole 301.

For example, as the second surface 322 of the waveguide 320 has the shape of a graph according to a sine function and/or a synthesis of a plurality of sine functions based on the virtual line 401 parallel to the first surface 321 facing the second surface 322, an internal volume of the waveguide 320 may be changed within a range of approximately 10%. The waveguide 320 may increase space efficiency of the waveguide 320 by improving sound quality of audio through the internal volume changed within the range of approximately 10%, instead of disposing a resonator to improve sound quality of audio.

According to an embodiment, the second surface 322 may include at least one valley portion 410 and at least one peak portion 420 connected to the at least one valley portion 410. The at least one valley portion 410 may be protruded toward the first surface 321 based on the virtual line 401. The at least one peak portion 420 may have curvature.

For example, in Equation 1, the at least one valley portion 410 may be a portion in which the distance d from the virtual line 401 to the second surface 322 has a negative value based on the virtual line 401. For example, in Equation 1, the at least one peak portion 420 may be a portion in which the distance d from the virtual line 401 to the second surface 322 has a positive value based on the virtual line 401. For example, the at least one valley portion 410 may be a portion of the second surface 322 protruding toward the first surface 321 from the virtual line 401. For example, the at least one peak portion 420 may extend from the at least one valley portion 410. The waveguide 320 may be configured such that a cross-sectional area of the waveguide 320 varies according to the length L of the waveguide 320 by including the at least one valley portion 410 and the at least one peak portion 420. The waveguide 320 may be configured such that the cross-sectional area varies, thereby improving sound quality of audio output to the outside of the electronic device 101 from the speaker 310 through the waveguide 320 and the speaker hole 301.

According to an embodiment, the at least one valley portion 410 may include a first valley portion 411 and a second valley portion 412 spaced apart from the first valley portion 411. The at least one peak portion 420 may include a first peak portion 421 having a radius of curvature r1 within a first reference range and a second peak portion 422 spaced apart from the first peak portion 421 by the second valley portion 412 and having a radius of curvature r2 within a second reference range smaller than the first reference range. The cross-sectional area of the waveguide 320 may have a minimum value at a position corresponding to the second valley portion 412.

For example, the first valley portion 411 may be a portion adjacent to the speaker 310 among the at least one valley portion 410. The second valley portion 412 may be a portion adjacent to the speaker hole 301 among the at least one valley portion 410. The second valley portion 412 may be a portion disposed between the peak portions 421 and 422. For example, the first peak portion 421 may be a portion extending from the first valley portion 411 to the second valley portion 412. The second peak portion 422 may be a portion extending from the second valley portion 412 to the speaker hole 301.

For example, the peak portions 421 and 422 may have positive curvature based on the virtual line 401 (or an internal space of the waveguide 320). As the first peak portion 421 has the radius of curvature r1 within the first reference range and the second peak portion 422 has the radius of curvature r2 within the second reference range smaller than the first reference range, a shape of the first peak portion 421 may be different from a shape of the second peak portion 422. For example, with reference also to Equation 4 or Equation 5, as the composite coefficient M has a value of 2 or 3, the second surface 322 may have a shape of a graph according to a synthesis of a plurality of sine functions based on the virtual line 401. Since the second surface 322 has the shape of the graph according to the synthesis of the plurality of sine functions, the shape of the first peak portion 421 may be different from the shape of the second peak portion 422. As the shape of the first peak portion 421 may be different from the shape of the second peak portion 422, the waveguide 320 may improve sound quality of audio output from the speaker 310 to the waveguide 320.

For example, a cross-sectional area of the waveguide 320 cut with respect to an xz plane may vary by a shape of the second surface 322. The cross-sectional area may have a minimum value at a position corresponding to the second valley portion 412. The second valley portion 412 may be referred to as a neck portion of the waveguide 320 in terms of being a portion in which the cross-sectional area has the minimum value, but is not limited thereto. The waveguide 320 may include the second valley portion 412 in which the cross-sectional area of the waveguide 320 is minimized, thereby improving sound quality of audio output from the speaker 310 to the waveguide 320.

According to an embodiment, the waveguide 320 may include a first region 320a surrounding the speaker 310 when the display 201 is viewed from above (e.g., when viewed from a +z direction) and a second region 320b extending from the first region 320a to the speaker hole 301 and at least partially bent. For example, the first region 320a may be a portion of the waveguide 320 that at least partially covers the speaker 310. For example, the first region 320a may be a portion from which audio is output from the speaker 310. For example, the first region 320a may be a region in which the shape of the second surface 322 does not have a shape according to Equation 1. For example, the second region 320b may be a region connected to the first region 320a and at least partially bent. For example, the second region 320b may be a region surrounding the electronic component 350. For example, the second region 320b may be a region in which the shape of the second surface 322 changes according to Equation 1. The waveguide 320 may include the second region 320b in which the shape of the second surface 322 changes according to Equation 1, thereby improving sound quality of audio output from the speaker 310 to the waveguide 320.

According to an embodiment, the electronic device 101 may include a speaker housing 450 partially disposed between the waveguide 320 and the speaker 310 and including at least one through hole 451 for transmitting audio output from the speaker 310 to the waveguide 320. For example, the speaker housing 450 may surround at least a portion of the speaker 310. For example, the speaker housing 450 may be referred to as a speaker housing in terms of reducing damage to the speaker 310 caused by external impact. For example, the speaker housing 450 may be disposed at least partially on the diaphragm 311 of the speaker 310. For example, audio output from the speaker 310 may be transmitted to the waveguide 320 through the at least one through hole 451 of the speaker housing 450.

According to an embodiment, the waveguide 320 may be disposed to be connected to the diaphragm 311 of the speaker 310 for audio output from the speaker 310 in the electronic device 101. For example, an end of the waveguide 320 may be disposed toward the diaphragm 311 of the speaker 310. For example, an end of the waveguide 320 may be disposed in a direction corresponding to a direction in which the diaphragm 311 of the speaker 310 faces. For example, the speaker 310 may be disposed to output audio in a direction toward the display 201 (e.g., the +z direction) on the waveguide 320. The speaker hole 301 may extend from the waveguide 320 in a direction in which the waveguide 320 faces the display 201 (e.g., the +z direction). For example, a direction in which the diaphragm 311 of the speaker 310 configured to output audio faces may correspond to a direction in which the speaker hole 301 connected to the outside of the electronic device 101 extends from the waveguide 320. As a direction in which audio is output from the speaker 310 to the waveguide 320 corresponds to a direction in which the audio is emitted to the outside of the electronic device 101 from the waveguide 320 through the speaker hole 301, the electronic device 101 may provide additional space for a waveguide having a shape according to Equation 1.

According to an embodiment, the second surface 322 may include a first portion 322a in which a distance a between the first surface 321 and the second surface 322 is constant along the second surface 322 and a second portion 322b in which the distance a between the first surface 321 and the second surface varies along the second surface 322 as the second point p2 is disposed. The first point p1 may be located between the first portion 322a and the second portion 322b. For example, the first portion 322a may be a portion of the second surface 322 disposed in the first region 320a of the waveguide 320. For example, the first portion 322a may be a portion in which the vertical distance a from the first surface 321 to the second surface 322 is constant. For example, the first portion 322a may be a portion at least partially surrounding the speaker 310. For example, the second portion 322b may be a portion disposed in the second region 320b of the waveguide 320. For example, the second portion 322b may be a portion in which the vertical distance a from the first surface 321 to the second surface 322 varies along the second surface 322. For example, the second portion 322b may be a portion extending from the first portion 322a to the speaker hole 301. For example, the second portion 322b may be a portion in which the shape of the second surface 322 varies according to Equation 1. The waveguide 320 may include the second portion 322b in which the distance a between the first surface 321 and the second surface varies along the second surface 322, thereby improving sound quality of audio output from the speaker 310 to the waveguide 320.

According to the above-described embodiment, the electronic device 101 may include the waveguide 320 including the second surface 322 extending from the speaker 310 to the speaker hole 301 and having a varying shape, thereby improving sound quality of audio output from the speaker 310. The second surface 322 may be at least partially spaced apart from the virtual line 401 parallel to the first surface 321 according to the ratio of the length L of the second surface 322 and the distance x from the first point p1 on the second surface 322 to the second point p2 spaced apart along the second surface 322, thereby improving sound quality of the audio.

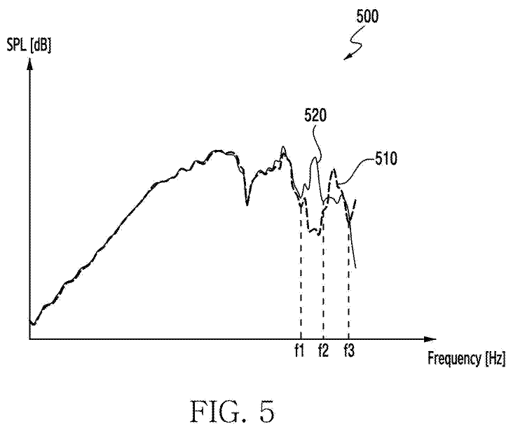

FIG. 5 is a graph illustrating sound pressure level according to a shape of a waveguide and frequency of sound according to an embodiment of the disclosure.

Referring to FIG. 5, the vertical axis of a graph 500 represents a sound pressure level (SPL) of audio when the audio is emitted to an outside of an electronic device (e.g., the electronic device 101 of FIG. 1) through a waveguide (e.g., the waveguide 320 of FIG. 3A) from a speaker (e.g., the speaker 310 of FIG. 3A) of the electronic device 101. The horizontal axis of the graph 500 represents a frequency of the audio output from the speaker 310. A graph 510 represents a sound pressure level of audio output through the waveguide 320 when a second surface (e.g., the second surface 322 of FIG. 3A) of the waveguide 320 is formed along the virtual line 401 of FIGS. 4A and 4B. A graph 520 represents a sound pressure level of audio output through the waveguide 320 when the second surface 322 of the waveguide 320 is spaced apart from the virtual line 401 according to a ratio of a length L of the second surface 322 and a distance x from a first point p1 on the second surface 322 to a second point p2 spaced apart along the second surface 322 according to Equation 1 of FIGS. 4A and 4B.

Referring to the graph 510, within an audio band between a first frequency f1 and a second frequency f2, when the second surface 322 is formed along the virtual line 401, the sound pressure level of the audio output from the speaker 310 through the waveguide 320 may be relatively low. Referring to the graph 520, within the audio band between the first frequency f1 and the second frequency f2, when the second surface 322 is spaced apart from the virtual line 401 according to the ratio of the length L of the second surface 322 and the distance x from the first point p1 on the second surface 322 to the second point p2 spaced apart along the second surface 322, the sound pressure level of the audio output from the speaker 310 through the waveguide 320 may be higher than in the case of the graph 510.

Referring to the graph 510, within an audio band between the second frequency f2 and a third frequency f3, when the second surface 322 is formed along the virtual line 401, the sound pressure level of the audio output from the speaker 310 through the waveguide 320 may be relatively high. Referring to the graph 520, within the audio band between the second frequency f2 and the third frequency f3, when the second surface 322 is spaced apart from the virtual line 401 according to the ratio of the length L of the second surface 322 and the distance x from the first point p1 on the second surface 322 to the second point p2 spaced apart along the second surface 322, the sound pressure level of the audio output from the speaker 310 through the waveguide 320 may be lower than in the case of the graph 510.

Referring to the graph 510 and the graph 520, within an audio band between the first frequency f1 and the third frequency f3, compared to the case in which the second surface 322 is formed along the virtual line 401, when the second surface 322 is spaced apart from the virtual line 401 according to the ratio of the length L of the second surface 322 and the distance x from the first point p1 on the second surface 322 to the second point p2 spaced apart along the second surface 322, the sound pressure level of the audio output through the waveguide 320 may be flattened. Through the flattened sound pressure level of the audio, the waveguide 320 may provide a user with improved sound quality of the audio.

According to the above-described embodiment, the waveguide 320 of the electronic device 101 may provide the user with improved sound quality of the audio by flattening the sound pressure level of the audio.

According to the above-described embodiment, a portable communication device (e.g., the electronic device 101 of FIG. 1) may comprise a housing (e.g., the housing 210 of FIG. 2A) including a speaker hole (e.g., the speaker hole 301 of FIG. 3A), and a speaker (e.g., the speaker 310 of FIG. 3A) in the housing configured to output audio. The portable communication device may comprise a waveguide (e.g., the waveguide 320 of FIG. 3A) extending from the speaker to the speaker hole to transmit the audio to an outside of the portable communication device. The waveguide may include a first surface (e.g., the first surface 321 of FIG. 3A), and a second surface (e.g., the second surface 322 of FIG. 3A) facing the first surface and spaced apart from the first surface. The second surface may be at least partially spaced apart from a virtual line (e.g., the virtual line 401 of FIG. 4A) parallel to the first surface according to a ratio of a length (e.g., L of FIG. 4A) of the second surface and a distance from a first point (e.g., the first point p1 of FIG. 4A) on the second surface to a second point (e.g., the second point p2 of FIG. 4A) spaced apart along the second surface. According to the above-described embodiment, the portable communication device may provide a path for the audio by including the waveguide. The second surface of the waveguide may be at least partially spaced apart from the virtual line according to the ratio of the length of the second surface and the distance between the first point and the second point, thereby improving sound quality of the audio. The above-described embodiment may have various effects including the effect described above.

According to an embodiment, a distance from the virtual line to the second surface according to the ratio may be determined by the equation below:

$$d = {\sum }_{m = 1}^{M} {C}_{m} sin ( 2 π mR ) \qquad Equation 1$$

d represents the distance from the virtual line to the second surface, Cm represents an amplitude constant, M represents a composite coefficient, and R represents the ratio of the length of the second surface and the distance from the first point on the second surface to the second point spaced apart along the second surface. According to the above-described embodiment, the second surface of the waveguide may be at least partially spaced apart from the virtual line according to the ratio of the length of the second surface and the distance between the first point and the second point, thereby improving the sound quality of the audio. The above-described embodiment may have various effects including the effect described above.

According to an embodiment, the composite coefficient may have a range of 1 to 3. According to the above-described embodiment, the second surface of the waveguide may be at least partially spaced apart from the virtual line according to the ratio of the length of the second surface and the distance between the first point and the second point, thereby improving the sound quality of the audio. The above-described embodiment may have various effects including the effect described above.

According to an embodiment, the waveguide may further include a third surface (e.g., the third surface 323 of FIG. 3A) extending from the first surface to the second surface, and a fourth surface (e.g., the fourth surface 324 of FIG. 3B) facing the third surface and spaced apart from the third surface. The fourth surface may be parallel to the third surface. According to the above-described embodiment, the waveguide may provide additional space for electronic components inside the portable communication device by including the third surface and the fourth surface. The above-described embodiment may have various effects including the effect described above.

According to an embodiment, the third surface may include at least one step portion (e.g., the at least one step portion 330 of FIG. 3A). According to the above-described embodiment, the third surface may improve the sound quality of the audio by including the at least one step portion. The above-described embodiment may have various effects including the effect described above.

According to an embodiment, the first surface may include a first bending portion (e.g., the first bending portion 321a of FIG. 4A) which is bent. The virtual line may include a second bending portion (e.g., the second bending portion 401a of FIG. 4A) facing the first bending portion and corresponding to the first bending portion. According to the above-described embodiment, the second surface of the waveguide may be at least partially spaced apart from the virtual line according to the ratio of the length of the second surface and the distance between the first point and the second point, thereby improving the sound quality of the audio. The above-described embodiment may have various effects including the effect described above.

According to an embodiment, the second surface may include a valley portion (e.g., the second valley portion 412 of FIG. 4A) protruding toward the first surface based on the virtual line, and at least one peak portion (e.g., the at least one peak portion 420 of FIG. 4A) extending from the valley portion and having curvature. According to the above-described embodiment, the waveguide may improve the sound quality of the audio by including the valley portion and the at least one peak portion. The above-described embodiment may have various effects including the effect described above.

According to an embodiment, the at least one peak portion may include a first peak portion (e.g., the first peak portion 421 of FIG. 4A) having a radius of curvature (e.g., r1 of FIG. 4B) within a first reference range, and a second peak portion (e.g., the second peak portion 422 of FIG. 4A) spaced apart from the first peak portion by the valley portion and having a radius of curvature (e.g., r2 of FIG. 4B) within a second reference range smaller than the first reference range. A cross-sectional area of the waveguide may have a minimum value at a position corresponding to the valley portion. According to the above-described embodiment, the waveguide may improve the sound quality of the audio by including the first peak portion and the second peak portion. The above-described embodiment may have various effects including the effect described above.

The portable communication device according to an embodiment may further comprise a display (e.g., the display 201 of FIG. 2A) coupled on the housing. The speaker may include a diaphragm (e.g., the diaphragm 311 of FIG. 3A) configured to output the audio toward the display. According to the above-described embodiment, the speaker may provide various user experiences to a user by including the diaphragm. The above-described embodiment may have various effects including the effect described above.

According to an embodiment, the waveguide may further include a first region (e.g., the first region 320a of FIG. 4A) surrounding the speaker when the display is viewed from above, and a second region (e.g., the second region 320b of FIG. 4A) extending from the first region to the speaker hole and at least partially bent. According to the above-described embodiment, the waveguide may improve the sound quality of the audio by including the second region which is at least partially bent. The above-described embodiment may have various effects including the effect described above.

According to an embodiment, the second surface may include a first portion (e.g., the first portion 322a of FIG. 4A) in which a distance (e.g., a of FIG. 4A) between the first surface and the second surface is constant along the second surface, and a second portion (e.g., the second portion 322b of FIG. 4A) in which the distance between the first surface and the second surface varies along the second surface as the second point is disposed. According to the above-described embodiment, the second surface may improve the sound quality of the audio by including the second portion in which the distance between the first surface and the second surface varies along the second surface. The above-described embodiment may have various effects including the effect described above.

According to an embodiment, the first point may be located between the first portion and the second portion. According to the above-described embodiment, the second surface of the waveguide may be at least partially spaced apart from the virtual line according to the ratio of the length of the second surface and the distance between the first point and the second point, thereby improving the sound quality of the audio. The above-described embodiment may have various effects including the effect described above.

According to an embodiment, a direction in which the audio is output from the speaker to the waveguide may correspond to the first direction in which the audio is emitted from the waveguide to the outside of the portable communication device through the speaker hole. According to the above-described embodiment, since the direction in which the audio is output from the speaker to the waveguide corresponds to the direction in which the audio is emitted from the waveguide to the outside of the portable communication device through the speaker hole, the portable communication device may provide additional space for the waveguide. The above-described embodiment may have various effects including the effect described above.

The portable communication device according to an embodiment may further comprise a speaker housing (e.g., the speaker housing 450 of FIG. 4A) partially disposed between the waveguide and the speaker and including at least one through hole for transmitting the audio output from the speaker to the waveguide. According to the above-described embodiment, by including the frame, the portable communication device may reduce damage to the speaker caused by external impact. The above-described embodiment may have various effects including the effect described above.

The portable communication device according to an embodiment may further comprise an electronic component (e.g., the first camera 205 of FIG. 2A or the electronic component 350 of FIG. 3A) at least partially surrounded by the waveguide. According to the above-described embodiment, by at least partially surrounding the camera, the waveguide may provide additional space in the portable communication device for the camera. The above-described embodiment may have various effects including the effect described above.

According to an embodiment, a portable communication device may comprise a housing including a speaker hole, a display coupled on the housing, and a speaker in the housing configured to output audio toward the display. The portable communication device may comprise a waveguide extending from the speaker to the speaker hole to transmit the audio to an outside of the portable communication device. The waveguide may include a first surface, and a second surface facing the first surface and spaced apart from the first surface. The speaker hole may be formed along the display. The second surface may be at least partially spaced apart from a virtual line parallel to the first surface according to a ratio of a length of the second surface and a distance from a first point on the second surface to a second point spaced apart along the second surface. According to the above-described embodiment, the portable communication device may provide a path for the audio by including the waveguide. The second surface of the waveguide may be at least partially spaced apart from the virtual line according to the ratio of the length of the second surface and the distance between the first point and the second point, thereby improving sound quality of the audio. The above-described embodiment may have various effects including the effect described above.

According to an embodiment, a distance from the virtual line to the second surface according to the ratio may be determined by the equation below:

d represents the distance from the virtual line to the second surface, Cm represents an amplitude constant, M represents a composite coefficient, and R represents the ratio of the length of the second surface and the distance from the first point on the second surface to the second point spaced apart along the second surface. According to the above-described embodiment, the second surface of the waveguide may be at least partially spaced apart from the virtual line according to the ratio of the length of the second surface and the distance between the first point and the second point, thereby improving the sound quality of the audio. The above-described embodiment may have various effects including the effect described above.

According to an embodiment, the composite coefficient may have a range of 1 to 3. According to the above-described embodiment, the second surface of the waveguide may be at least partially spaced apart from the virtual line according to the ratio of the length of the second surface and the distance between the first point and the second point, thereby improving the sound quality of the audio. The above-described embodiment may have various effects including the effect described above.

According to an embodiment, the second surface may include a valley portion protruding toward the first surface based on the virtual line, and at least one peak portion extending from the valley portion and having curvature. According to the above-described embodiment, the waveguide may improve the sound quality of the audio by including the valley portion and the at least one peak portion. The above-described embodiment may have various effects including the effect described above.

According to an embodiment, the second surface may include a first portion in which a distance between the first surface and the second surface is constant along the second surface, and a second portion in which the distance between the first surface and the second surface varies along the second surface as the second point is disposed. According to the above-described embodiment, the second surface may improve the sound quality of the audio by including the second portion in which the distance between the first surface and the second surface varies along the second surface. The above-described embodiment may have various effects including the effect described above.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A portable communication device comprising:
a housing including a speaker hole extending in a first direction;
a display, coupled on the housing, extending in a second direction perpendicular to the first direction;
a speaker disposed in the housing, the speaker being configured to output audio toward the display; and
a waveguide for transmitting the audio to an outside of the portable communication device, the waveguide extending from the speaker to the speaker hole,
wherein the waveguide includes:
a first surface, which is at least partially bent, and
a second surface facing the first surface, the second surface being spaced apart from the first surface,
wherein the speaker hole is formed along a periphery of the display and is configured to emit the audio, which is propagated in the second direction through the first surface and the second surface, toward the outside in the first direction, and
wherein the second surface is at least partially spaced apart from a virtual line parallel to the first surface according to a ratio of a length of the second surface and a distance from a first point on the second surface to a second point spaced apart along the second surface.

2. The portable communication device of claim 1,
wherein a distance from the virtual line to the second surface is defined by the following equation:
$$d = {\sum }_{m = 1}^{M} {C}_{m} sin ( 2 π mR ) ,$$
and
wherein d represents the distance from the virtual line to the second surface, Cm represents an amplitude constant, M represents a composite coefficient, and R represents the ratio of the length of the second surface and the distance from the first point on the second surface to the second point spaced apart along the second surface.

3. The portable communication device of claim 2,
wherein the composite coefficient is between one and three, inclusively.

4. The portable communication device of claim 1,
wherein the waveguide further includes:
a third surface extending from the first surface to the second surface, and
a fourth surface facing the third surface, the fourth surface being spaced apart from the third surface, and
wherein the fourth surface is parallel to the third surface.

5. The portable communication device of claim 4,
wherein the third surface includes at least one step portion.

6. The portable communication device of claim 1,
wherein the first surface includes a first bending portion which is bent, and
wherein the virtual line includes a second bending portion corresponding to the first bending portion, the second bending portion facing the first bending portion.

7. The portable communication device of claim 1,
wherein the second surface includes:
a valley portion protruding toward the first surface based on the virtual line, and
at least one peak portion extending from the valley portion, the at least one peak portion including having curvature.

8. The portable communication device of claim 7,
wherein the at least one peak portion includes:
a first peak portion including a radius of curvature within a first reference range, and
a second peak portion spaced apart from the first peak portion by the valley portion, the second peak portion including a radius of curvature within a second reference range smaller than the first reference range, and
wherein a cross-sectional area of the waveguide has a minimum value at a position corresponding to the valley portion.

9. The portable communication device of claim 1,
wherein the speaker includes a diaphragm configured to output the audio toward the display.

10. The portable communication device of claim 9,
wherein the waveguide further includes:
a first region surrounding the speaker when the display is viewed from above, and
a second region extending from the first region to the speaker hole, the second region being at least partially bent.

11. The portable communication device of claim 1,
wherein the second surface includes:
a first portion in which a distance between the first surface and the second surface is constant along the second surface, and
a second portion in which the distance between the first surface and the second surface varies along the second surface with respect to the second point.

12. The portable communication device of claim 11,
wherein the first point is located between the first portion and the second portion.

13. The portable communication device of claim 1,
wherein a direction in which the audio is output from the speaker to the waveguide corresponds to the first direction in which the audio is emitted from the waveguide to the outside of the portable communication device through the speaker hole.

14. The portable communication device of claim 1 further comprising:
a speaker housing partially disposed between the waveguide and the speaker, the speaker housing including at least one through hole for transmitting the audio output from the speaker to the waveguide.

15. The portable communication device of claim 1 further comprising:
an electronic component at least partially surrounded by the waveguide.

16. A portable communication device comprising:
a housing including a speaker hole;
a display defining at least a portion of a front side of the portable communication device;
a speaker disposed in the housing, the speaker being configured to output audio toward the display; and
a waveguide for transmitting the audio to an outside of the portable communication device, the waveguide extending from the speaker to the speaker hole,
wherein the waveguide includes:
a first surface, which is at least partially bent, and
a second surface facing the first surface, the second surface being spaced apart from the first surface, and
wherein the second surface is at least partially spaced apart from a virtual line parallel to the first surface according to a ratio of a length of the second surface and a distance from a first point on the second surface to a second point spaced apart along the second surface.

17. The portable communication device of claim 16,
wherein a distance from the virtual line to the second surface is defined by the following equation:
$$d = {\sum }_{m = 1}^{M} {C}_{m} sin ( 2 π mR ) ,$$
and
wherein d represents the distance from the virtual line to the second surface, Cm represents an amplitude constant, M represents a composite coefficient, and R represents the ratio of the length of the second surface and the distance from the first point on the second surface to the second point spaced apart along the second surface.

18. The portable communication device of claim 17,
wherein the composite coefficient is between one and three, inclusively.

19. The portable communication device of claim 16,
wherein the second surface includes:
a valley portion protruding toward the first surface based on the virtual line, and
at least one peak portion extending from the valley portion, the at least one peak portion including curvature.

20. The portable communication device of claim 16,
wherein the second surface includes:
a first portion in which a distance between the first surface and the second surface is constant along the second surface, and
a second portion in which the distance between the first surface and the second surface varies along the second surface with respect to the second point.
